(19) United States
(12) Patent Application Publication
(10) Pub. No.: US 2014/0266592 A1
(43) Pub. Date: Sep. 18, 2014

(54) NETWORK GATEWAY SYSTEM AND METHOD

(71) Applicants: Paul A. Dahl, Pleasant Grove, UT (US); Scott McCall, Provo, UT (US); John P. Filoso, Pleasant Grove, UT (US); David Mayne, Eagan, MN (US); Jordan Husney, Minneapolis, MN (US)

(72) Inventors: Paul A. Dahl, Pleasant Grove, UT (US); Scott McCall, Provo, UT (US); John P. Filoso, Pleasant Grove, UT (US); David Mayne, Eagan, MN (US); Jordan Husney, Minneapolis, MN (US)

(73) Assignee: DIGI INTERNATIONAL INC., MINNETONKA, MN (US)

(21) Appl. No.: 13/842,633

(22) Filed: Mar. 15, 2013

(51) Int. Cl. B60R 25/00

(52) U.S. Cl. CPC H04Q 7/245
USPC 340/5.71; 370/338

(57) ABSTRACT

A system and method for adding a gateway to a first device having a first network connector. An embedded gateway module includes a processor, a memory connected to the processor and first and second network interfaces, wherein the first network connection uses a first network protocol and the second network connection uses a second network protocol. The embedded gateway module is installed in the first device, wherein installing includes sharing the first device's first network connector. The gateway then connects the gateway through the first network to a device manager application at a remote location, connects the gateway module to the second network, installs gateway program data for receiving data from a second device over the second network and storing the received data as channels of data and installs presentation program data for presenting the channel data to applications running on the cloud.

### BACKGROUND

A network gateway is an internetworking system capable of joining together two networks that use difference base protocols. The typical network gateway is either a stand alone device or is designed directly into a device. Wireless gateways often are stand alone boxes that have an Ethernet cable and power cable attached for connectivity and power. As network gateways have continued to proliferate, they have changed and become more cost effective; they continue to appear in new applications. Designing and communicating with a network gateway can still, however, be a complicated process.

What is needed is a system and method for adding network gateway functionality that addresses these issues, and other issues that will become apparent while reading the following.

### BRIEF DESCRIPTION OF THE FIGURES

FIG. 1 shows a device control system according to the present invention;

FIG. 2 shows an automatic garage door opener version of the device control system of FIG. 1;

FIG. 3 shows an alternate device control system according to the present invention;

FIG. 4 shows an automatic garage door opener version of the device control system of FIG. 3;

FIG. 5 illustrates a method of communicating with a device according to the present invention; and

FIG. 6 illustrates a more detailed version of the automatic garage door opener of FIG. 2.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

A system 100 for controlling devices is shown in FIG. 1. In the system in FIG. 1, a device manager application 102 communicates with a network gateway 106 across a network 104 such as the Internet. In turn, gateway 106 communicates with a device 110 across a network 108 such as a mesh network. In the embodiment shown, gateway 106 includes a first network connection 114 that communicates with network 104, a second network connection 118 that communicates with network 108, and a gateway function 116 for communicating between protocols on network 104 and protocols on network 108. In the embodiment shown in FIG. 1, network 108 is a 802.15.4/Zigbee network.

In one embodiment, network connection 114 is a Wi-Fi connection to network 104. In another embodiment, network connection 114 is an Ethernet connection. In another embodiment, network connection 114 is a cellular connection.

In the example embodiment shown in FIG. 1, a user interface device 112, such as a smartphone, communicates with device manager application 102 across a network 104 such as the Internet. In one such embodiment, an application running on user interface device 112 presents a device interface for controlling device 110. A user can enter commands on user interface device 112 and control device 110 accordingly.

In one embodiment, network gateway 106 is a traditional gateway such as a Digi ConnectPort X2, manufactured by Digi International of Minnetonka, Minn. In another embodiment, network gateway 106 is implemented in software on a personal computer, and communicates with the second network 108 via a network adapter (such as the XStick USB Adapter manufactured by Digi International of Minnetonka, Minn.). In yet another embodiment, network gateway 106 is an embedded gateway as will be described below. In yet another embodiment, network gateway 106 is implemented in software on a personal computer, and communicates with device 110 via network connection 114 (termed a “virtual gateway”).

An example embodiment of system 100 is shown in FIG. 2. In the example shown in FIG. 2, device 110 is a garage door opener. In operation, garage door opener 110 is connected to a radio module 120 that communicates across network 108 with gateway 106. Gateway 106 communicates in turn to device manager application 102 via network 104. The garage door opener 110 of FIG. 2 receives commands and provides status to an application running in the cloud on device manager application 102. That status is read in turn by smartphone 112 and displayed for the user.

In one example embodiment, as is shown in FIG. 3, a gateway module 206 adds gateway functionality to an existing internet connected box 200. This is the embedded gateway described above.

In the example shown in FIG. 3, a device 200 is connected to the internet 104. In the example shown, a gateway module 206 is an embedded device added to device 200. Gateway module 206 uses the network connection of device 200 to access a cloud-based application 102 through network 104. In one such embodiment, device 200 is retrofitted with gateway functionality by soldering module 206 into existing network 114 connections. In another embodiment, device 200 includes a socket for receiving module 206.

In one embodiment, gateway functionality is distributed between module 206 and application 102. A low cost module 206 with reduced computational power can be designed by moving portions of the gateway functionality from module 206 to application 102. In one such embodiment, a distributed gateway application executing in either the cloud or in device 206 coordinates the gateway functions executed in application 102 with those executed in gateway module 126.

In the embodiment shown in FIG. 3, module 206 includes local control module 202. In one such embodiment, local control module 202 includes input/output lines, communications lines or a combination of input/output lines and communications lines 210. Lines 210 are used in one embodiment for reading status and controlling hardware 204 local to device 200.

In one embodiment, network connection 114 is a Wi-Fi connection to network 104. In another embodiment, network connection 114 is an Ethernet connection. In another embodiment, network connection 114 is a cellular connection.

In the embodiment shown in FIG. 3, gateway module 206 communicates through physical layer 118 to another network 108 in order to provide the gateway function. In the embodiment shown in FIG. 3, network 108 is a 802.15.4/Zigbee network.

In one example embodiment, gateway module 206 is designed such that it can be embedded within another device such as a set top box, a gaming console, a PC, plug-in vehicle charging station or some other internet connected device. Once connected, gateway module 206 automatically connects to cloud device manager/gateway application 102 over internet 104.

Another example embodiment of the garage door opener application of FIG. 2 is shown in FIG. 4. Once again, garage door opener 110 is connected to a radio module 120 that communicates across network 108 with gateway 106. Gateway 106 communicates in turn to device manager application 102 via network 104. The garage door opener 110 of FIG. 2 receives commands and provides status to an application running in the cloud on device manager application 102. That status is read in turn by smartphone 112 and displayed for the user.

In one embodiment, device 200 is an internet-connected plug-in charging station. In one example embodiment, embedded gateway module 206 is added to the charging station and creates a mesh network 108 that is able to communicate with garage door opener 110 via radio module 120. Local control lines 210 can be used to control aspects of the charging station, aspects of the garage door control, or to control, for example, the garage lights. More importantly, in some example embodiments, local control lines 210 are used in by an application running on smartphone 112, to check the status not only of the garage door, but also the charging station.

As noted above, wireless gateways often are implemented as stand alone boxes that have an Ethernet cable and power cable attached to for connectivity and power. In one embodiment, gateway module 126 includes a reasonably high performance microprocessor with external flash and ram that is also connected to an RF subsection. In some such gateways, the gateways run an operating system like Linux, but also have the ability to run Python scripts so that customers can run their code on the gateway.

In one embodiment, an attempt was made to significantly reduce the cost of a next generation gateway. We found that the cost can be lowered by placing portions of the gateway application in a cloud application. In one such embodiment, a gateway module 206 is built on a small PCB that can be connected to Ethernet within the parent device 200. It receives its power from the parent device as well as provides I/O lines, ADC and standard communication interfaces (UART,SPI) for local parent device control from the cloud. In one embodiment, as is shown in FIG. 4, gateway module 206 includes a processor 130, a memory 132, and two network connections (114 and 118). FIG. 4 also illustrates distributed gateway application 134, in which portions of the gateway application 134 are executed in a cloud application in 102 and portions in processor 130.

The approach described above reduces the cost of deploying gateways and changes the approach to their design and deployment. This approach allows for this type of gateway to be deployed without adding another stand-alone gateway in the home. In addition the module's particular gateway application can be distributed between the module and the device cloud, allowing for cheaper lower cost hardware to be used.

What has been described is an embedded gateway which provides easy connectivity to device cloud. By embedding this device and providing automatic connectivity to a device cloud, design in of a network gateway is simplified. The device cloud allows functions and features to be offloaded from the gateway. Gateway features could be Smart Energy Energy Service Interface (ESI), Home automation gateway, Smart Energy gateway, could be imbedded in a Smart Energy in home display.

The embedded approach of FIGS. 3 and 4 is advantageous because the gateway 206 is embedded within a device 200. That is, it no longer stands alone. As noted above, the gateway function can be distributed between device 206 and cloud application 102. Therefore, less computing power is needed, and the processor can be less expensive.

In some embodiments, a device 106 or 206 automatically connects to the device cloud when connected. Also, by providing local communication and I/O line controls, gateway module 206 is able to directly control local hardware, not just the remote 802.15.4 devices. Finally, one can load different personas on the gateway to tune each module 206 for the task. In some embodiments, for example, there is a different 802.15.4/Zigbee profile for each of Smart Energy, Home automation, etc.

In one embodiment, distributed gateway application 134 of FIG. 4 is a Python application. In one such embodiment, application 134 calls software modules written in C or Python. In some embedded gateways, for instance, you might want to hardwire as much as possible into the firmware, so you would use C. On gateways with more processing power, such as the application running on a personal computer, in some embodiment Python is used in order to provide a fast, easy and flexible interface.

In one embodiment, application 134 is designed to abstract out the underlying gateway hardware. In one such embodiment, application 134 communicates with a variety of gateway hardware devices using hardware application programming interfaces (APIs). In one such embodiment, a first API is designed to communicate with a traditional gateway via traditional gateway driver. Such a driver is used, for instance, to read and write from the Digi ConnectPort X2 described above.

In one such embodiment, a second API is designed to communicate with an embedded gateway such as is shown in FIGS. 3 and 4 via an embedded gateway driver and a third API is designed to communicate via a USB interface with a USB-based gateway via a USB gateway driver. Such a driver is used, for instance, to read and write from the XStick USB Adapter described above.

In one embodiment, each application 134 includes a conversion utility used to process data into a uniform format before passing the data on to the device manager application 102 executing in the cloud. One such embodiment is based on Digi's DIA, as detailed below. In another embodiment, application 134 includes the conversion utility used to process data into a uniform format before passing the data on to the device manager application 102 executing in the cloud. One such embodiment is based on Digi's XIG, as detailed below.

In some embodiments, data is formatted into channels before being sent to application 102. In some embodiments, channels are defined for both data and control packets. Other control and data transfer mechanisms can be used as well.

In some channel embodiments, data sent from application 102 to gateway modules 106 and 206 is formatted into channels. In one such embodiment, a channel for data to be sent from gateway module 106 or 206 may be formed from data read from device 110, or may be formed by combining data from two or more channels into a third channel and sending the third channel data to application 102. Similarly, data received at gateway modules 106 and 206 could be separated into two or more distinct channels before being sent to device 110 in order, for example, to control operation of device 110. In one embodiment, the iDigi DIA is used to manage the channel data. iDigi DIA is a channel database that receives sample data from device 110 on one or more channels, saves the channel data to a channel database and presents data from the channel database in the form of presentations. Each channel is an accessible discrete element in the channel database and can be access by presentations according to a set of permissions. In one embodiment, Digi's XBee Internet Gateway (XIG) is used to access channel data from, for instance, smartphone 112.

In one embodiment, as is shown in FIG. 5, a method 300 of installing a gateway includes installing the gateway at 302. At 304, the gateway 106 connects to the device 110 to be controlled via second network 108 and connects to device manager application 102 via first network 104 at 306. At 308, program data is installed that allows gateway 106 to receive and format channel data from device 110. At 310, program data is installed that allows gateway 106 to present channel data from gateway 106 to application 102. At 312, a channel data application is installed on a user device 112 such as a smartphone. The channel data application allows user device 112 to receive and display channel data through device manager application 102 and to write channel data information back to gateway 106 through device manager application 102. In one embodiment, channel data written from device 112 is presented to device 110 as control.

In some embodiments, other message mechanism are used instead of channels, or in addition to channels, to transfer data and control information between an application operating on user device 112 and device 110.

Next, the automatic garage door opener example will be discussed in greater detail. An example smartphone enabled automatic garage door opener is illustrated in FIG. 6. In the embodiment shown in FIG. 6, garage door opener 110 includes a garage door opener circuit 122 and an automatic garage door opener unit 124. Almost all automatic garage door opener units 124 have a hard-wired button that when pressed opens the door. To remotely control the door, all that's needed is a simple circuit 122 that can simulate this button press. That circuit is then connected to a radio module 120, as shown in FIGS. 2, 4 and 6, that will allow you to wirelessly communicate with a network 108 inside your home.

In one embodiment, radio module 120 is an XBEE ZB radio module manufactured by Digi International of Minnetonka, Minn. The XBee ZB radio module speaks the ZigBee protocol. ZigBee is great for home automation projects. It's secure and inexpensive but most importantly it's a mesh network—a network that can extend its range using other radios intelligently and automatically. For example, if your garage is too far away from your gateway you can simply add another radio in the middle to facilitate the wireless connection.

In one embodiment, garage door opener 110 includes a door sensor 126 used to detect whether the door is open or closed. In one such embodiment, sensor 126 is a magnetic reed switch sensor 122; it will tell you when the door is fully closed.

One embodiment of a printed circuit board that can be used in circuit 122 is sold as Digi-Key kit #6811380-KIT-ND at digikey.com. For security the printed circuit board adds static protection on the sensor inputs, and a circuit that stops the garage door from being toggled in the event of a power outage. Assembly is simple: find an empty spot on the PCB and note its silkscreen label (e.g., capacitor C6). Locate each item in the materials list online and solder it in place, taking care to orient it correctly.

In a typical automatic garage door opener installation, two wires connect the door opener button to garage door opener unit 124. In one embodiment, two wires are run from a relay on circuit 122 to the two garage door opener button wires on unit 124. When the relay activates, it momentarily shorts the two wires together, simulating a button press.

Once circuit 124 is installed and connected to radio module 120, it is time to connect the circuit to internet 104. First, radio module 120 is connected through network 108 to a gateway 106. Then, we have to make gateway accessible over internet 104.

In one embodiment, gateway 106 is a Digi ConnectPort X2 ZigBee-to-Ethernet gateway. The ConnectPort X2 can be programmed using the Python language. In one embodiment, we use an open source Python application called the XBee Internet Gateway (XIG) to create the link between the garage door opener unit 124 and the internet.

In an alternate embodiment, one could connect an XBee to a personal computer acting as gateway 106 as noted above in order to make this link.

The Digi ConnectPort X2 gateway creates a connection from the gateway to a special free service called iDigi. This connection acts like a secure tunnel back to the gateway 106 in our home. Using the proper credentials, remote applications can talk to iDigi and pass information all the way to devices 110 on mesh network 108. So why use a dedicated gateway and not a PC? For the same reasons we use wi-fi routers instead of PCs set up for internet sharing: simplicity, reliability, cost, and efficient power consumption.

First, connect your ConnectPort X2 gateway 106 to your internet connection by plugging it into a spare Ethernet port on your switch or router. Open a web browser and go to idigi.com.

Click the Get Started Now button and create an account on the iDigi Developer Cloud (a free version of iDigi Device Cloud that allows up to 5 devices). Once logged into iDigi Manager Pro, go to the Devices page and click the Add (+) button. The application will look for the gateway 106 on your local network. Once gateway 106 is found, click on it to select it, and then click Add. After a minute, click Refresh and you'll see your gateway 106 listed as “Connected.” This means gateway 106 can talk to the world and the world (if it has the proper credentials) can speak to your gateway 106 and devices 110.

Power up your XBee Pulse I/O, right-click on ConnectPort X2 on the Devices list, then select Discover to add XBee radio node 120 to the list as well.

To control how gateway 106 speaks to the world, you need to load some extension software onto it. The XBee Internet Gateway (XIG) is a Python program that allows our mobile phone app to send remote commands to open and close the garage door. It also streams SSL-encrypted sensor information from the XBee Pulse I/O to the iDigi service, which allows our mobile app to know whether the door is open or shut. The XIG runs on Windows, Macintosh and Linux computers as well as the Digi ConnectPort X series of dedicated gateways.

Download XIG version 1.4.0 or newer from code.google.com/p/xig, and unpack the archive into a folder on your desktop.

Log into the iDigi Developer Cloud, go to the Devices page, double-click on your gateway, and select Python from the list of configuration sections. Click the Upload icon, browse to your unpacked XIG files, and upload all files except the software license and README file.

Once the upload completes, type xig.py into the Auto-start Command Line field and check the Enable checkbox. Close the configuration pane, right-click on the gateway, and select Administration->Reboot. Gateway 106 is configured.

An XBee Garage Door Application can be downloaded from the Android market, or a browser interface can be used from smartphone 112 to access data from device 110 and issue commands to device 110.

In one embodiment, a garage door is displayed on the screen of smartphone 112. If the door is closed, the corresponding garage door is closed. If the door is displayed open, then the corresponding garage door is open. In one embodiment, a swipe up on the closed garage door will send a command to unit 124 to open the garage door, while a swipe down on the open garage door will send a command to unit 124 to close the garage door. A similar swipe method can be used to open or close other doors.

The above described device manager system 100 significantly lowers the cost and difficulty of implementing internet-enabled gateway functionality in a 802.15.4/Zigbee deployment. The deployment can now be done based on known software modules.

The above described embedded gateway module 206 also reduces the cost of implementing gateway functionality in a 802.15.4/Zigbee deployment. By embedding this device and providing automatic connectivity to a device cloud, deployment can now be done without adding an additional box, and makes it easy to add smart energy services to existing products. Gateway module 206 also reduces certification and hardware design expenses because the RF is on the gateway module. The device cloud allows functions and features to be offloaded from the gateway. The above-described gateways can be used to build a Smart Energy Energy Service Interface (ESI), a home automation gateway, a Smart Energy gateway, or could be used to embed Smart Energy in a home display.

Although specific embodiments have been illustrated and described herein, it will be appreciated by those of ordinary skill in the art that any arrangement which is calculated to achieve the same purpose may be substituted for the specific embodiments shown. The invention may be implemented in various modules and in hardware, software, and various combinations thereof, and any combination of the features described in the examples presented herein is explicitly contemplated as an additional example embodiment. This application is intended to cover any adaptations or variations of the example embodiments of the invention described herein. It is intended that this invention be limited only by the claims, and the full scope of equivalents thereof.

What is claimed is:

1. A system, comprising:
a network gateway having a first network connection with a first network protocol and a second network connection with a second network protocol;
a device manager application operating in a remote location and connected across a public network to the network gateway;
a communications module connected to the network gateway over the second network; and
a device connected to the communications module, wherein the device receives commands from the communications module and returns status information;
wherein the network gateway receives data from the device in the form of channels, transmits control information to the device in the form of channels and stores data representing activity on the channels in a channel database; and
wherein channel information stored in the channel database is accessible by users via queries to the device manager application and wherein the queries result in the transfer of data from the channel database to the user via the device manager application.

2. The system according to claim 1, wherein the first network protocol is Ethernet and the second network protocol is ZigBee.

3. The system according to claim 2, wherein the communications module is a ZigBee radio.

4. The system according to claim 1, wherein gateway functionality is distributed across the network gateway and the device manager application.

5. The system according to claim 4, wherein the distributed gateway functionality includes the ability to convert channel data for presentation to applications in the cloud.

6. A network gateway, comprising:
a device having a first network connection, wherein the first network connection uses a first network protocol; and
an embedded network gateway installed in the device, wherein the embedded network gateway includes:
a processor;
a memory connected to the processor; and
first and second network interfaces, wherein the first network connection uses the first network protocol and the second network connection uses a second network protocol;
wherein the first network interface of the embedded network gateway is communicatively coupled to the first network connection of the device such that they share a first network connector.

7. The gateway according to claim 6, wherein the first network protocol is Ethernet and the second network protocol is ZigBee.

8. The gateway according to claim 7, wherein the communications module is a ZigBee radio.

9. The gateway according to claim 6, wherein gateway program code is stored in memory of the embedded network gateway and executed by the processor to provide gateway functionality.

10. The gateway according to claim 6, wherein, in operation, gateway functionality is distributed between the embedded network gateway and a device manager application running in the cloud.

11. The gateway according to claim 10, wherein the distributed gateway functionality includes the ability to convert channel data for presentation to applications in the cloud.

12. The gateway according to claim 6, wherein the embedded network gateway further includes one or more communication lines that can be used to communicate with portions of the device.

13. The gateway according to claim 6, wherein the embedded network gateway further includes one or more input/output lines connected to portions of the device.

14. A garage door opener, comprising:
a network gateway having a first network connection with a first network protocol and a second network connection with a second network protocol;
a device manager application located in a remote location and connected across a public network to the network gateway;
a communications module connected to the network gateway over the second network; and
an automatic garage door opener connected to the communications module, wherein the device receives commands from the communications module and returns status information;
wherein the network gateway receives data from the device in the form of channels, transmits control information to the device in the form of channels and stores data representing activity on the channels in a channel database; and
wherein channel information stored in the channel database is accessible by users via queries to the device manager application and wherein the queries result in the transfer of data from the channel database to the user via the device manager application.

15. The garage door opener according to claim 14, wherein the first network protocol is Ethernet and the second network protocol is ZigBee.

16. The garage door opener according to claim 15, wherein the communications module is a ZigBee radio.

17. The garage door opener according to claim 14, wherein the garage door opener includes a door sensor, wherein the door sensor determines if the door is open or closed and stores the data as door state information.

18. The garage door opener of claim 17, wherein the door state information is formatted into a channel and stored in the channel database.

19. The garage door opener of claim 18, wherein gateway functionality is distributed between the network gateway and the device manager application running in the cloud and wherein the distributed gateway functionality includes the ability to convert channel data for presentation to applications in the cloud.

20. A method of adding a gateway to a first device having a first network connector, the method comprising:
providing an embedded gateway module, wherein the embedded gateway module includes:
a processor;
a memory connected to the processor; and
first and second network interfaces, wherein the first network connection uses a first network protocol and the second network connection uses a second network protocol;
installing the embedded gateway module into the first device, wherein installing includes sharing the first device's first network connector;
connecting the gateway through the first network to a device manager application at a remote location;
connecting the gateway module to the second network;
installing gateway program data for receiving data from a second device over the second network and storing the received data as channels of data; and
installing presentation program data for presenting the channel data to applications running on the cloud.

21. The method of claim 20, wherein the gateway program code includes program code for automatically connecting to a cloud-based device manager across the Internet.

22. The method of claim 20, wherein the method further comprises installing an application on a user device that transfers channel data through the device manager application between the smartphone and the gateway.
